(19) United States
(12) Patent Application Publication
(10) Pub. No.: US 2016/0230825 A1
(43) Pub. Date: Aug. 11, 2016

(54) PARKING BRAKE CALIPER

(71) Applicant: J.JUAN, S.A., Gavá (ES)

(72) Inventor: Joaquin GARCIA BLANCO, Castelldefels (ES)

(21) Appl. No.: 15/026,139

(22) PCT Filed: Sep. 29, 2014
(86) PCT No.: PCT/EP2014/070796

§ 371 Date: Mar. 30, 2016

(30) Foreign Application Priority Data
Oct. 3, 2013 (EP) 13382386.4

(51) Int. Cl. F16D 65/18

(52) U.S. Cl. CPC F16D 65/18; F16D 2121/04

(57) ABSTRACT

Parking brake caliper, comprising: a brake actuator (10) with a drive shaft (11) and a drive head (12), configured to transmit a push force (F1), an actuation lever (16) configured to transmit a rotational movement (R) onto the drive shaft (11) and a displacement mechanism (20) configured to transform the rotational movement (R) into a linear movement (L), capable of generating the push force (F1); a framework (30) that houses a piston (31) configured to be displaced along the length of a cylinder (32) and; a set of brake pads (40a, 40b), configured to apply pressure to a brake disc (100). Said caliper (1) transmits the push force (F1) of the drive head (12) to the piston (31) via a point contact (C).

### FIELD OF THE INVENTION

The present invention refers to a parking brake caliper for vehicles in general and particularly for motorcycles, having been designed to avoid becoming stuck or blocked, these being problems which usually occur in said pieces as a result of friction on their main components.

### BACKGROUND OF THE INVENTION

Parking brake calipers constitute a security device designed to stop a vehicle from moving, mainly when it is parked. They usually prevent the vehicle from travelling in a longitudinal direction or, as is the case with some motorcycles, from travelling in a crosswise direction, in order to prevent swaying, which causes them to turn over. These devices have become a basic element in large, heavy motorcycles and their use is generally obligatory. They serve to immobilize the wheels to prevent them from accidentally turning as a result of the vehicle's inertia whilst it is parked. Their shortfall is that they may cause the motorcycle to travel in an uncontrolled manner, this movement being capable of lifting the motorcycle's bike lift or kick stand, thereby causing the motorcycle to fall over.

Current parking brake calipers are usually formed by a brake actuator with a built in actuation lever, which can be either manual or automatic (for example, driven by an electric motor), configured to transmit a rotational movement onto a drive shaft, which in turn has a drive head, configured to transmit a push force. A displacement mechanism makes it possible to transform said rotational movement into a linear movement of the drive shaft, which is capable of generating the push force. A piston housed inside a framework is displaced along the length of a cylinder defined in the same, owing to the linear movement of the drive shaft. The displacement of said piston in turn gives rise to pressure being applied on a set of brake pads, configured to apply friction to a brake disc, usually arranged in one or more of the vehicle's wheels.

It must be pointed out that in order for these calipers to work, torsion must always be applied to the drive shaft, caused by the rotational movement of the actuation lever. Given that the drive head of said shaft is immobilized and in direct contact with the piston, this gives rise to gradual wear between other fixed and mobile parts of the caliper over time, thus resulting in deviation in the linear movement of said drive shaft. In turn, this increases friction, mainly between the piston and the drive head (owing to the considerable surface contact between the two), which finally causes the drive shaft to become stuck or blocked. Said friction may become high enough to mean that the user is unable to release the shaft, either manually or automatically. This is largely inconvenient.

The present invention resolves the above described problem, using a brake caliper whose configuration makes it possible to transmit the push force of the drive head to the piston via a point contact, in order to reduce friction between the drive head and the piston. Over time, wear caused by friction is concentrated in the area where this point-contact is made. This minimizes deviation of the drive shaft, in turn reducing the wear produced between other fixed and mobile parts of the caliper and by proxy, the friction caused by said deviation. This makes it possible to successfully avoid sticking in many cases and in other cases, extends the operational cycle notably before the same begins to appear.

### DESCRIPTION OF THE INVENTION

The present invention refers to a parking brake caliper, comprising:
a brake actuator, with:
   a drive shaft, with a drive head configured to transmit a push force;
   an actuation lever, configured to transmit a rotational movement onto the drive shaft and;
   a displacement mechanism, configured to transform the rotational movement into a linear movement of the drive shaft, said linear movement being capable of generating the push force;
a framework, inside which a piston is housed, this piston being configured to travel along the length of a cylinder defined in the same, owing to the linear movement of the drive shaft and;
a set of brake pads, configured to press a vehicle's brake disc, by means of the piston being moved forwards by the push force.

The caliper, object of the present invention, is characterized in that the push force is transmitted from the drive head to the piston via a point contact, in order to reduce the friction between the drive head and the piston. Said point contact is caused by a flat surfaced body coming into contact with a spherical, semi-spherical or oval surfaced body. In turn, said body may be formed and/or mechanized on the same drive head or on the piston itself, forming an indivisible unit as regards the same or, it may form an independent intermediate body arranged between both.

According to a preferred embodiment of the present invention, said body corresponds to a thrust ball arranged between the piston and the drive head, said ball being configured to transmit the push force of the drive head to the piston, to thereby cause it to move forwards. This gives rise to indirect transmission, i.e. via the thrust ball, between the drive head and the piston.

The thrust ball is preferably arranged with freedom of rotation between the piston and the drive head, remaining joined to one or another by means of fastening means, which prevent said ball from being able to come out of its housing.

The thrust ball may also be arranged freely in the housing set up for such ends, in such a way that, in addition to having freedom of rotation, it has a certain degree of translation movement on one or all of the X, Y, Z coordinate axes, even with the fastening means needed to prevent it from coming out of its housing. According to a particular embodiment of the present invention, the thrust ball is loose within the housing, without fastening means. Therefore, the thrust ball has a certain degree of freedom of movement, owing to the fact that there is a certain amount of space or clearance in said housing. Similarly, there is also a minimum thrust ball clearance or space, relative to the drive head and to the piston. This also facilitates the assembly of these components as the caliper is being manufactured.

When the brake is operated, the thrust ball comes into contact with the drive head and, given its mobility, corrects its position, adapting to a possible deviation of the drive shaft. The thrust ball therefore has a point contact with the drive head. For this reason, in addition to the spherical or substantially spherical shape of the ball, the drive had comprises a flat surfaced drive end, which is perpendicular to the drive shaft. Friction wear caused by the repeat operation of the caliper is concentrated on said flat surface, always ensuring a point contact with the thrust ball. This means that the resulting push force vector transmitted onto the piston is kept in line with the resulting push force vector transmitted by the drive head onto the ball.

Wear being concentrated on the flat surface helps to reduce and/or prevent wear in other components, such as the actuator or framework. This makes it possible to successfully minimize deviation of the drive shaft, as well as the sticking or blockage brought about by the same.

The displacement mechanism preferably comprises:
a fixed shell joined to the framework, with an internal thread and;
a mobile shell, with an external thread, threaded in the internal thread, axially crossed by the drive shaft, attached to the same and in turn, attached to the actuation lever via a rotation end, perpendicular to said lever.

The actuation lever may be operated in various ways, whether manual or automatic. The most common include using a brake cable, which in turn comprises an end connected to the lever itself and another end connected to a manual drive (for example a handle) or an automatic drive (for example an electric motor). When the brake is operated, the cable is tensed, thus causing the lever to rotate in one direction, which in turn causes the piston to move forwards, pressure thereby being applied to the brake disc. After braking, the cable is kept tensed. When the brake is released, a back drive (for example a mechanical energy accumulator of the spring variety) pushes the lever, causing it to rotate in the opposite direction, the brake disc thereby being freed.

The displacement mechanism also preferably comprises a flexible dust-guard cover, with a first end joined to the framework or to the fixed shell and a second end joined to the mobile shell. Of the various closure options, the displacement mechanism preferably comprises a closure nut, configured to join the actuation lever to the mobile shell.

As previously indicated, the thrust ball is arranged between the piston and the drive head, barely separated from said elements by the presence of a minimum clearance or space. Therefore, according to a preferred embodiment of the present invention, the piston comprises an axial housing on an internal face of the same, which has an opening, through which the thrust ball is introduced during the mounting thereof. Said axial housing is configured to house the thrust ball and enable its freedom of movement. The housing is formed by a cavity, the bottom of which is opposite to the opening. The cavity may be cylindrical or prismatic in form, whilst the bottom may be in the form of a pyramid, a cone or be flat, it being possible, in any case, for it to take on other geometrical shapes and/or combinations thereof.

The housing preferably comprises a fore-chamber in communication with the opening, said fore-chamber being configured to house the drive head. The fore-chamber comprises a recoil washer, configured to enable the piston to travel back along the length of the cylinder, by means of a recoil force generated by the linear movement of the drive shaft. In turn, the drive head comprises a recoil flywheel, configured to transmit the recoil force onto the recoil washer.

The set of brake pads preferably comprises an external friction plate and an internal friction plate, which are arranged in such a way that they are opposite to one another, a space being defined between them, which is designed to accommodate the brake disc. Said internal friction plate is configured to receive pressure caused by the piston moving forwards and to move against the external friction plate.

### BRIEF DESCRIPTION OF THE DRAWINGS

Below is a brief description of a series of drawings, which serve to facilitate a better understanding of the present invention and are expressly related with one embodiment of said invention, presented as a non-limiting example thereof.

FIG. 1 is a longitudinal section of the parking brake caliper, object of the present invention, represented as the brake is in operation and illustrating the piston moving forwards.

FIG. 2 gives a detailed view of the piston, when the brake is operation.

FIG. 3 is a longitudinal section of the parking brake caliper, object of the present invention, represented as the brake is being freed, illustrating the piston recoiling.

### DETAILED DESCRIPTION OF THE INVENTION

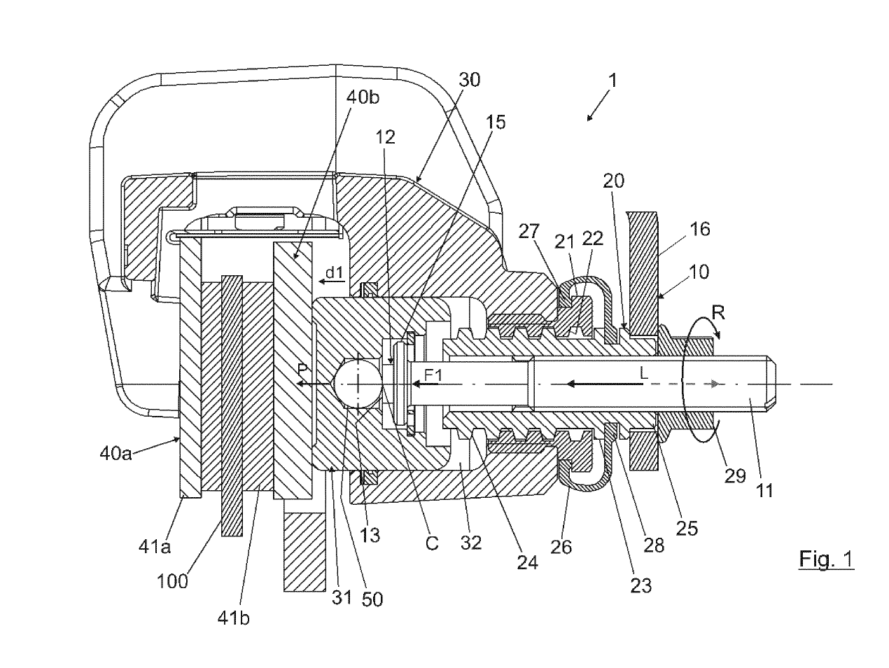

FIG. 1 is a longitudinal section of the parking brake caliper (1), object of the present invention, represented as the brake is being operated. As can be seen, the caliper (1) comprises:
a brake actuator (10), with:
   a drive shaft (11) with a drive head (12) configured to transmit a push force (F1);
   an actuation lever (16), configured to transmit a rotational movement (R) onto the drive shaft (11) and;
   a displacement mechanism (20), configured to transform the rotational movement (R) into a linear movement (L) of the drive shaft (11), said linear movement (L) being capable of generating the push force (F1);
a framework (30), inside which a piston (31) is housed, this piston being configured to move along the length of a cylinder (32) defined in the same, owing to the linear movement (L) of the drive shaft (11) and;
a set of brake pads (40a, 40b), configured to apply pressure to a vehicle's brake disc (100), by means of the piston (31) moving forwards (d1) as a result of the push force (F1).

The caliper, object of the present invention, is characterized in that the push force (F1) is transmitted from the drive head (12) to the piston (31) via a point contact (C), in order to reduce the friction between the drive head (12) and the piston (31). According to the present example, said point contact (C) is materialized by means of a thrust ball (50) arranged between the piston (31) and the drive shaft (12), said ball (50) being configured to transmit the push force (F1) of the drive head (12) to the piston (31), thereby causing it to move forwards (d1). As a result, an indirect transmission occurs, i.e. via the thrust ball (50), between the drive head (12) and the piston (31).

As can be seen, the thrust ball (50) is spherical, with a point contact (C) with the drive head (12). Likewise, the drive head (12) comprises a flat surfaced drive end (13), which is perpendicular to the drive shaft (11). Friction wear caused by repeat operation of the caliper (1) is concentrated on said flat surface of the drive end (13), always ensuring a point contact with the thrust ball (50). This allows the vector resulting from the push force (F1) transmitted onto the piston (31) to be kept in line with the vector resulting from the push force (F1) transmitted by the drive head (12) on the ball (50).

Wear being concentrated on the flat surface of the drive end (13) helps to reduce and/or prevent wear in other components, such as the actuator (10) and, mainly in its displacement mechanism (20). This makes it possible to successfully minimize deviation of the drive shaft (11), as well as sticking or blockage brought about by the same.

According to the present preferred embodiment example, the displacement mechanism (20) comprises:
a fixed shell (21) joined to the framework (30), with an internal thread (22) and;
a mobile shell (23) with an external thread (24), threaded in the internal thread (22), axially crossed by the drive shaft (11), attached to the same and in turn, attached to the actuation lever (16) via a rotation end (25), perpendicular to said lever (16).

The displacement mechanism (20) also comprises a flexible dust-guard cover (26) with a first end (27) joined to the framework (30) and a second end (28) joined to the mobile shell (23). The fact that it is flexible allows the mobile shell (23) to move. In turn, the displacement mechanism (20) comprises a closure nut (29), configured to join the actuation lever (16) to the mobile shell (23).

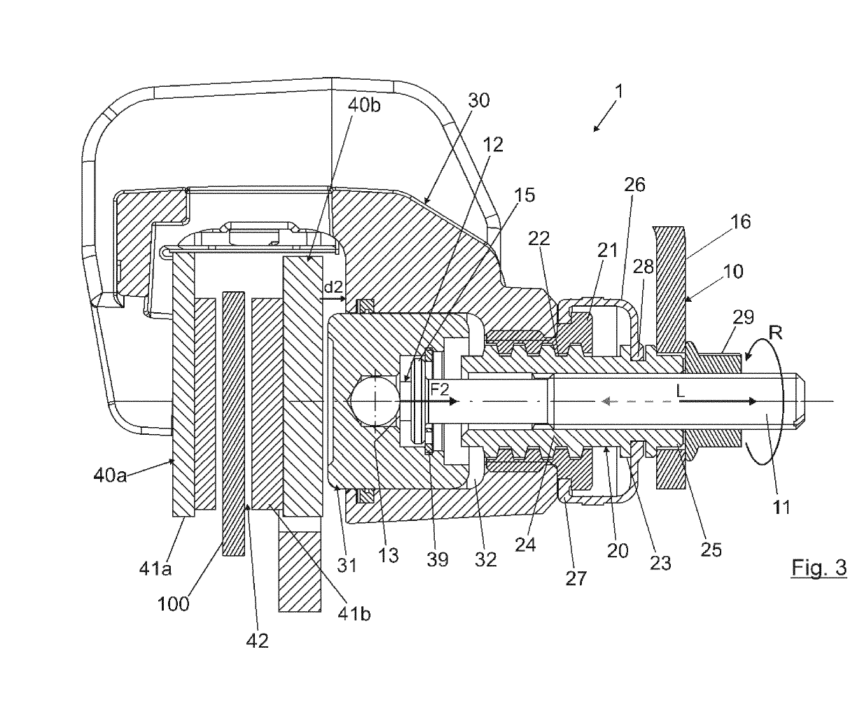

The set of brake pads (40a, 40b) comprises an external friction plate (41a) and an internal friction plate (41b), arranged in such a way that they are opposite to one another and a space (42), (FIG. 3) being defined between them, intended to accommodate the brake disc (100). Said internal friction plate (41b) is configured to receive pressure (P) generated by the piston (31) moving forwards (A) and to move against the external friction plate (41a).

The linear movement of the shaft (L) is represented by an arrow pointing in two directions. The direction corresponding to the drive shaft (11) moving forwards is highlighted in a continuous line.

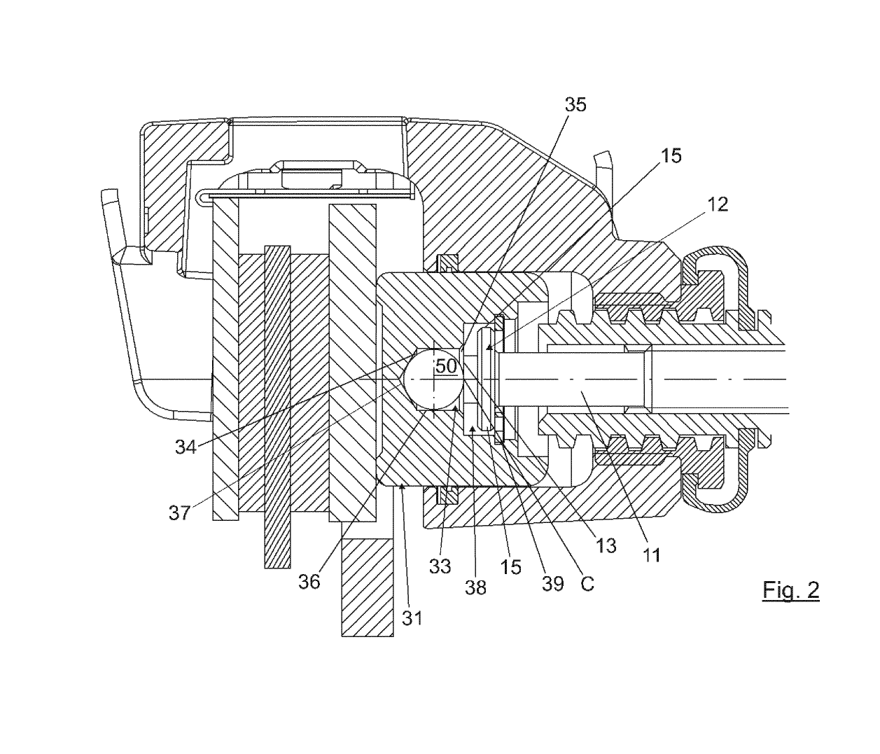

FIG. 2 provides a detailed view of the piston (31) when the brake is in operation. As can be seen, the piston (31) comprises an axial housing (33) on an internal face (34) of the same, with an opening (35), through which the thrust ball (50) is introduced during the mounting thereof. Said axial housing (33) is configured to house the thrust ball (50) and enable its freedom of movement (before operating the brake). The housing (33) is formed by a cavity (36), the bottom (37) of which is opposite to the opening (35). According to the present preferred embodiment example, the cavity (36) is cylindrical in shape, whilst the bottom (37) may be cone shaped.

The housing (33) comprises a fore-chamber (38) in communication with the opening (35), where said fore-chamber (38) is configured to house the drive head (12). The fore-chamber (38) comprises a recoil washer (39).

FIG. 3 is a longitudinal section of the parking brake caliper (1), object of the present invention, represented as the brake is being released. As can be seen, the recoil washer (39) is configured to allow the piston (31) to recoil (M2) along the length of the cylinder (32) by means of a recoil force (F2) generated by the linear movement (L) of the drive shaft (11). In turn, the drive head (12) comprises a recoil flywheel (15), which is configured to transmit the recoil force (F2) onto the recoil washer (39).

The linear movement of the shaft (L) is represented by an arrow pointing in two directions. The direction corresponding to the drive shaft (11) recoiling is highlighted in a continuous line.

1. Parking brake caliper, comprising:
a brake actuator, with:
a drive shaft, with a drive head, configured to transmit a push force (F1);
an actuation lever, configured to transmit a rotational movement (R) onto the drive shaft and;
a displacement mechanism, configured to transform the rotational movement (R) into a linear movement (L) of the drive shaft, said linear movement (L) being capable of generating the push force (F1);
a framework, inside which a piston is housed, configured to travel along the length of a cylinder defined in the same, owing to the linear movement (L) of the drive shaft and;
a set of brake pads, configured to apply pressure to a vehicle's brake disc, by means of the piston travelling forwards (d1), caused by the push force (F1);
said caliper comprising a thrust ball arranged between the piston and the drive head, said ball being configured to transmit the push force (F1) from the drive head to the piston via a point contact (C); and in that the piston comprises an axial housing on an internal face of the same, which has an opening, where said axial housing is configured to house the thrust ball and enable its freedom of rotation.

2. Parking brake caliper according to claim 1, wherein the point contact (C) is produced by contact with a flat surface and a spherical, semi-spherical or oval shaped surface.

3. Parking brake caliper according to claim 1, wherein the drive head comprises a flat surfaced drive end, which is perpendicular to the drive shaft.

4. Parking brake caliper according to claim 1, wherein the displacement mechanism comprises:
a fixed shell joined to the framework, with an internal thread and;
a mobile shell with an external thread, threaded in the internal thread, axially crossed by the drive shaft, attached to the same and joined, in turn, to the actuation lever via a rotation end, which is perpendicular to said lever.

5. Parking brake caliper according to claim 4, wherein the displacement mechanism comprises a flexible dust-guard cover with a first end joined to the framework and a second end joined to the mobile shell.

6. Parking brake caliper according to claim 4, wherein the displacement mechanism comprises a closure nut, configured to join the actuation lever to the mobile shell.

7. Parking brake caliper according to claim 1, wherein the housing is formed by a cavity, the bottom of which is located opposite to the opening.

8. Parking brake caliper according to claim 7, wherein the cavity is cylindrical or prismatic in shape and in that the bottom is a pyramid shape, cone shape or flat.

9. Parking brake caliper according to claim 7, wherein the housing comprises a fore-chamber in communication with the opening, where said fore-chamber is configured to house the drive head.

10. Parking brake caliper according to claim 9, wherein the fore-chamber comprises a recoil washer, configured to allow the piston to recoil (M2) along the length of the cylinder, as a result of a recoil force (F2) generated by the linear movement (L) of the drive shaft.

11. Parking brake caliper according to claim 10, wherein the drive head comprises a recoil flywheel, which is configured to transmit the recoil force (F2) on the recoil washer.

12. Parking brake caliper according to claim 1, wherein the set of brake pads comprises an external friction plate and an internal friction plate, arranged in such a way that they are opposite one another and a space being defined between them, intended to accommodate the brake disc.

13. Parking brake disc according to claim 12, wherein the internal friction plate is configured to receive pressure (P) caused by the piston moving forwards (d1) and to move against the external friction plate.
